(19) United States
(12) Patent Application Publication
(10) Pub. No.: US 2013/0108328 A1
(43) Pub. Date: May 2, 2013

(54) IMAGE FORMING APPARATUS

(71) Applicant: CANON KABUSHIKI KAISHA, Tokyo (JP)

(72) Inventor: Osamu Ariizumi, Matsudo-shi (JP)

(73) Assignee: CANON KABUSHIKI KAISHA, Tokyo (JP)

(21) Appl. No.: 13/654,699

(22) Filed: Oct. 18, 2012

(30) Foreign Application Priority Data
Nov. 2, 2011 (JP) 2011-241442

(51) Int. Cl. G03G 15/09

(52) U.S. Cl. 399/276

(57) ABSTRACT

An image forming apparatus includes developing devices each including a developer carrying member for carrying a developer to develop an electrostatic latent image; and an image forming station capable of forming a toner image on a recording material by overlapping toner images formed by the developing devices, wherein in at least two of the developing devices, the developer carrying member has a surface provided with grooves at predetermined intervals, and wherein angles of the grooves relative to respective directions of generatrixes of the developer carrying members are different from each other.

### FIELD OF THE INVENTION AND RELATED ART

The present invention relation an image forming apparatus including a developing device for forming a visualized image by developing an electrostatic latent image formed on an image bearing member by an electrophotographic type, electrostatic recording type or the like process. More particularly, it relates to the image forming apparatus comprising a plurality of such developing devices each including a developer carrying member for carrying the developer to a developing position, wherein said developer carrying member having a surface provided with grooves.

In an image forming apparatus or the like an electrophotographic type copying machine, the developing device is provided to visualize the electrostatic latent image formed on the image bearing member such as a photosensitive drum by depositing a developer onto the electrostatic latent image. In such a developing device, a developing sleeve is used to carry the developer to a developing position where it is opposed to the photosensitive drum. It is known that the surface of the developing sleeve is sand-blasted in order to improve a developer feeding performance. With long term use, the sand-blasted developing sleeve loses the developer feeding power because of wearing of the surface thereof. Japanese Laid-open Patent Application Hei 5-333691 and Japanese Laid-open Patent Application 2007-127907 disclose that a plurality of grooves are formed on the surface of the developing sleeve to suppress the reduction of the feeding power due to the wearing of the surface.

With the developing sleeve provided with the groove on the surface disclosed in the Japanese publications, a developer amount on the surface of the sleeve is different between the grooved area and non-grooved area when passing a developer regulating member for regulating a coating amount on the developing sleeve. Then, a toner amount moving to the photosensitive drum is different between the grooved area and the non-grooved area, with the result of production of banding (unevenness) at the intervals of the grooves in the output image.

Particularly, when a plurality of developing devices are used, and the, groove configurations of the developing sleeves are the same, the outputs of the respective color images are overlaid after an image transfer step, with the result of more remarkable banding than in a monochromatic image formation.

### SUMMARY OF THE INVENTION

Accordingly, it is a principal object of the present invention to provide an image forming apparatus and a developing device with which an image defect attributable to overlying of periodical unevennesses of the images resulting from grooves formed on the developer carrying members can be suppressed.

According to an aspect of the present invention, there is provided an image forming apparatus comprising a plurality of developing devices each including a developer carrying member for carrying a developer to develop an electrostatic latent image; and an image forming station capable of forming a toner image on a recording material by overlapping toner images formed by said developing devices, wherein in at least two of said developing devices, said developer carrying member has a surface provided with grooves at predetermined intervals, and wherein angles of the grooves relative to respective directions of generatrixes of said developer carrying members are different from each other.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of an image forming apparatus according to Embodiments 1, 2 of the present invention.

FIG. 2 is a cross-sectional view of a developing device according to the present invention.

FIG. 3 is a longitudinal sectional view of the developing device according to the present invention.

FIG. 4 is a substantial illustration of a developing sleeve according to embodiment 1.

FIG. 5 is a substantial illustration of a developing sleeve according to Embodiment 2.

FIG. 6 is a substantial illustration of a developing sleeve according to Embodiment 1.

FIG. 7 is an illustration of an image processing according to Embodiment 1 of the present invention.

### DESCRIPTION OF THE PREFERRED EMBODIMENTS

### Embodiment 1

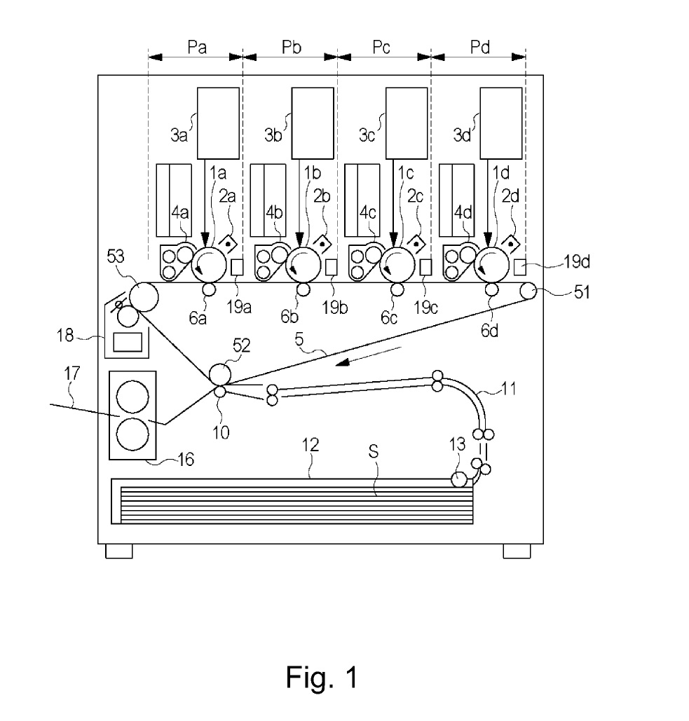

FIG. 1 shows a schematic illustration of a full-color image forming apparatus of an electrophotographic type according to an embodiment of the present invention.

The image forming apparatus includes four image forming stations P (Pa, Pb, Pc, and Pd). Each of image forming stations Pa-Pd is provided with an electrophotographic photosensitive member in the form of a drum, that is, a photosensitive drum 1 (1a, 1b, 1c, 1d) rotatable in a direction indicated by the arrow (counterclockwise direction), as an image bearing member. Around the photosensitive drum 1 (1a, 1b, 1c, 1d), there are provided a charger 2 (2a, 2b, 2c, 2d), a laser beam scanner 3 (3a, 3b, 3c, 3d) as exposure means, and a developing device 4 (4a, 4b, 4c, 4d). Further, the apparatus comprises a transfer roller 6 (6a, 6b, 6c, 6d), cleaning means 19 (19a, 19b, 19c, 19d).

The image forming stations Pa, Pb, Pc, and Pd have similar structures.

For example, the photosensitive drums 1a, 1b, 1c, 1d of the respective image forming stations Pa, Pb, Pc, and Pd have the same structures. Therefore, the photosensitive drum 1a, 1b, 1c or 1d will be hereinafter called “photosensitive drum 1”. Similarly, the process means around the image forming stations Pa, Pb, Pc, Pd have the same structures, and will be called thereafter, “charger 2”, “laser beam scanner 3”, “developing device 4”, “transfer roller 6” and “cleaning means 19”.

The image formation sequence of the whole image forming apparatus in a normal mode will be described.

First, the photosensitive drum 1 is charged uniformly by the charger 2.

In the normal mode, the photosensitive drum 1 rotates in the clockwise direction indicated by the arrow at a process speed) of the 286 mm/sec, for example.

The uniformly charged photosensitive drum 1 is exposed, by the laser beam scanner 3, to scanning laser beam modulated in accordance with an image signal. The laser beam scanner 3 comprises a semiconductor laser, which emits the laser beam controlled corresponding to an original image information signal outputted by an original reading device having a photoelectric conversion element such as CCD.

By doing so, a surface potential of the photosensitive drum 1 charged by the charger 2 is changed in an image portion, thus forming an electrostatic latent image on the photosensitive drum 1. The electrostatic latent image is reverse-developed by the developing device 4 into a visualized image, that is, a toner image.

In this embodiment, the developing device 4 is of a two component developing system using a developer containing toner and carrier particles.

These steps are carried out in the image forming stations Pa, Pb, Pc, Pd, so that yellow, magenta, cyan and black toner images are formed on the photosensitive drums 1a, 1b, 1c, 1d, respectively.

In this embodiment, below each image forming station Pa, Pb, Pc, Pd, there is provided an intermediary transfer belt as an intermediary transfer member 5. The intermediary transfer belt 5 is supported around rollers 51, 52, 53 and is rotatable to the direction indicated by the arrow.

The toner images on the photosensitive drums 1 (1a, 1b, 1c, 1d) are temporarily transferred onto the intermediary transfer belt 5 which is the intermediary transfer member, by transfer rollers 6 (6a, 6b, 6c, 6d) as primary transferring means. By doing so, the yellow, magenta, cyan and black toner images are overlaid the intermediary transfer belt 5 so that a full-color image is formed. Toner particles remaining on the photosensitive drum 1 without being transferred is collected by cleaning means 19.

The full-color image on the intermediary transfer belt 5 is transferred onto a transfer material S such as paper supplied by a sheet feeding roller 13 and a sheet feeding guide 11 from a sheet feeding cassette 12, by a secondary transfer roller 10 as secondary transferring means. Toner particles remaining on the surface of the intermediary transfer belt 5 without being transferred are collected by intermediary transfer belt cleaning means 18.

On the other hand, the transfer material S having the transferred toner image is fed to a fixing device (heat roller fixing device) 16, where the image is fixed, and then, the transfer material S is discharged to the sheet discharge tray 17.

In this embodiment, the photosensitive drum 1 is an organic photosensitive member in the form of a drum, but another material such as an inorganic photosensitive member, that is, an amorphous silicon photosensitive member, for example. In addition, a photosensitive member in the form of a belt is usable. The charging type, the transfer type, the cleaning type and the fixing type are not limited to the above-described types. The use of the intermediary transfer member is not inevitable, and the images may be directly transferred onto the recording material from each image bearing member.

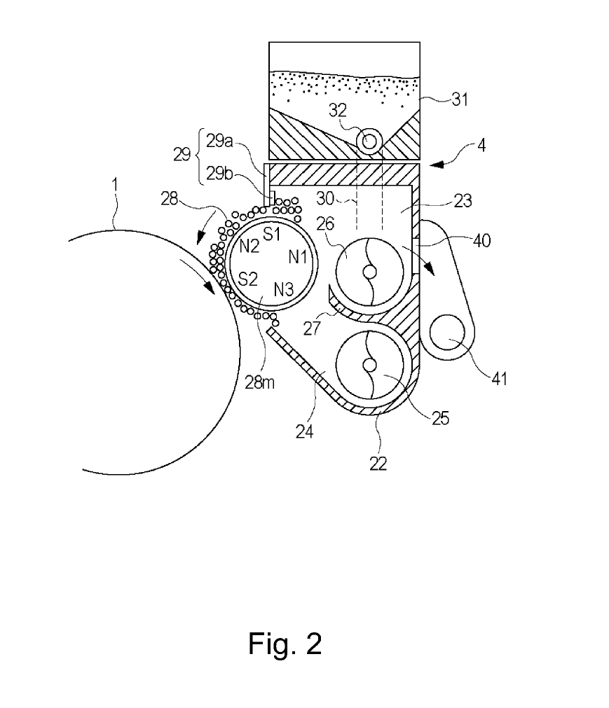

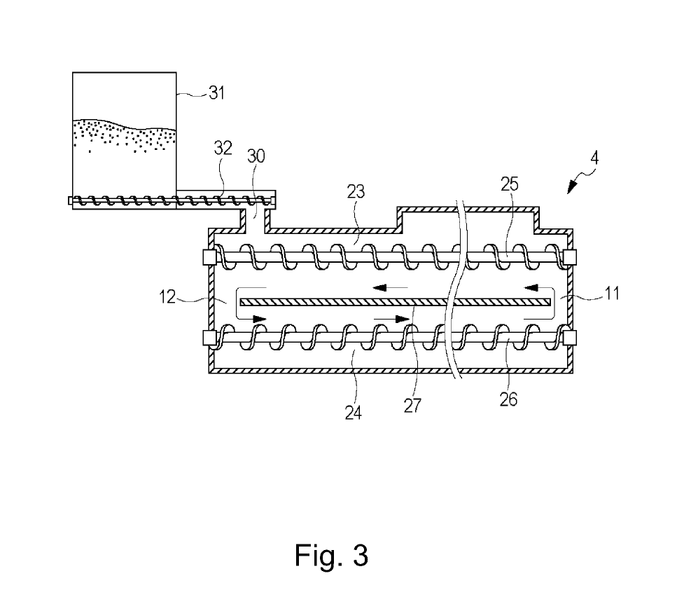

Referring to FIGS. 2 and 3, the operation of the developing device 4 will be described. FIGS. 2 and 3 are sectional views of the developing device 4 according to this embodiment, and are a so-called vertical stirring type developing device.

Developing device 4 according to this embodiment comprises a developing container 22 containing a two component developer including toner and carrier particles. In the developing container 22, there is provided a developing sleeve 28 as a developer carrying member for carrying the developer to a developing position where it is opposed to the photosensitive member, and the developing container 22 is provided with a chain cutting member 29 for regulating the chains of the developer carried on the developing sleeve 28.

By this embodiment, the inside of the developing container 22 is partitioned into an upper chamber, that is, a developing chamber 23 and a lower chamber, that is, a stirring chamber 24, by a partition 27 extending in a direction perpendicular to the sheet of the drawing at the substantially central portion, and the developer is accommodated in the developing chamber 23 and the stirring chamber 24.

The stirring chamber 24 and the developing chamber 23 are provided withed first and second feeding screws 25, 26, respectively as developer stirring and feeding means. The second feeding screw 26 extends substantially in parallel with the axial direction of the developing sleeve 28 at a bottom portion of the developing chamber 23 and is rotatable to feed the developer in the developing chamber 23 along the axial direction thereof. The first feeding screw 25 extends substantially in parallel with the second feeding screw 26, and is rotatable to feed the developer in the stirring chamber 24 to the direction opposite to the feeding direction of the second feeding screw 26. In this manner, by the feeding of the rotation of the first and second feeding screws 25, 26, the developer is circulated between the developing chamber 23 and the stirring chamber 24 through openings (communicating portions) 11, 12 at the opposite end portions of the partition 27.

The first feeding screw 25 has an outer diameter of Φ 20 mm, a shaft diameter of 6 mm and a screw pitch of 25 mm, and the rotational speed is 650 rpm, in this embodiment. The second feeding screw 26 has an outer diameter of Φ 20 mm, a shaft diameter of 6 mm, and a screw pitch of 25 mm, and the rotational speed is 680 rpm, in this embodiment.

In this embodiment, the developing container 22 is provided with an opening at a position corresponding to a developing zone opposing the photosensitive drum 1, the developing sleeve 28 is rotatable and is exposed through the opening to the photosensitive drum.

The developing sleeve 28 has a diameter of 20 mm, and the photosensitive drum 1 has a diameter of 40 mm, wherein a distance therebetween is approx. 380 μm in the closest region between the developing sleeve 28 and the photosensitive drum 1. By this arrangement, the developer fed to the developing zone is contacted to the photosensitive drum 1 during the developing operation. The developing sleeve 28 is made of a non-magnetic material such as aluminum or stainless steel, and encloses a magnet roller 28m as magnetic field means which is provided non-rotatably. The magnet roller 28m has a developing pole S2 at a position opposed to the photosensitive drum 1 in the developing zone, and a magnetic pole S1 at a position opposed to the chain cutting member 29. Furthermore, it has a magnetic pole N1 between the magnetic poles S1, S2, and magnetic poles N2 and N3 at the positions opposed to the developing chamber 23 and the stirring chamber 24, respectively. A rotational frequency of the developing sleeve 28 in the image forming operation is 492 rpm (peripheral speed ratio relative to the photosensitive member is 180%).

The developing sleeve 28 rotates in the direction indicated by the arrow (counterclockwise direction) in the Figure during the developing operation. The developing sleeve 28 carrying the developer of a layer thickness regulated by the chain cutting member 29 to the developing zone where it is opposed to the photosensitive drum 1. In this manner, the developer is supplied to the electrostatic latent image formed on the photosensitive drum 1 to develop the latent image.

The regulating blade 29 (chain cutting member) comprises a plate-like non-magnetic member 29a of aluminum or the like extending along an axis of the developing sleeve 28, and a magnetic member 29b of steel material. The regulating blade 29 is disposed upstream of the photosensitive drum 1 with respect to the rotational moving direction of the developing sleeve. The toner and carrier particles of the developer passes between the developing sleeve 28 and a free end portion of the chain cutting member 29 and is fed into the developing zone. By adjusting a gap between the regulating blade 29 and the surface of the developing sleeve 28, the chain cutting amount to the magnetic developer brush formed on the developing sleeve 28 is regulated so as to adjust the developer amount fed into the developing zone. In this embodiment, the regulating blade 29 regulates the developer coating amount per unit area on the developing sleeve 28 to 30 mg/cm̂2. The gap between the regulating blade 29 and the developing sleeve 28 is 200−1000 μm, preferably 400-700 μm. In this embodiment, it is 580 μm.

Referring to FIGS. 2 and 3, a supplying method of the developer in this embodiment will be described. Above the developing device 4, there is provided a hopper 31 for accommodating the two component developer (containing mixed toner and carrier particles) to be supplied. The hopper 31 constituting toner supplying means is provided with a screw feeding member 32 in a lower portion, and one end portion of the feeding member 32 extends to the position of the developer supply opening 30 provided at a front end of the developing device 4.

A amount of the toner corresponding to the consumption for the image formation is supplied into the developing container 22 through the developer supply opening 30 from the hopper 31 by a rotational force of the feeding member 32 and the gravity of the developer. In this manner, the developer is supplied into the developing device 1 from the hopper 31.

The supply amount of the developer is determined approximately by the rotational frequency of the supplying screw 32 which is the feeding member, and the rotational frequency is determined by unshown toner supply amount control means. As for a method for controlling the toner supply amount, there are known various methods, in one of which a toner content of the two component developer is detected optically or magnetically, and in another of which a reference latent image on the photosensitive drum 1 is developed, and the density of the toner image is detected, for example. Any one of which is properly selected by ordinary skilled in the art.

A binarization method in the present invention will be described.

As for a binarization method in a tone gradation reproduction, various methods have been proposed. Most widely used is a dithering method. In the dithering method, one pixel of an input signal obtained by reading corresponds to one pixel of binary recording.

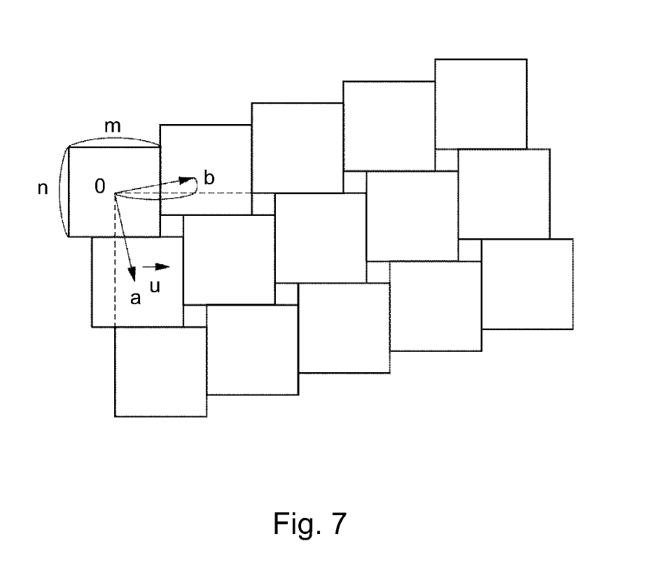

As shown in FIG. 7, one block of a dither pattern of basic halftone dot (basic cell) comprises m×n pixels provided by such a binarization method, and when there are a plurality of such blocks, halftone dots having a screen angle can be provided by properly offsetting the blocks. If the offset (shift vector) u=(a, b), the provided screen angle θ is,

θ=tan ̂−1 (b/a)

Here, if the density to output is different, the configuration of the basic halftone dot in the dither pattern in one block is different, but when a plurality of the blocks are arranged, the screen angle of the output print is maintained constant by setting the screen angle at the constant screen angle in the image processing.

Using different screen angles for respective colors is advantageous since when misalignment between color images occurs due to the uneven speed of the intermediary transfer belt and/or the offset in the registration, the uniformity of the colors can be maintained, and the production of the moire fringes can be suppressed.

The developing sleeve 28 used by this embodiment will be described.

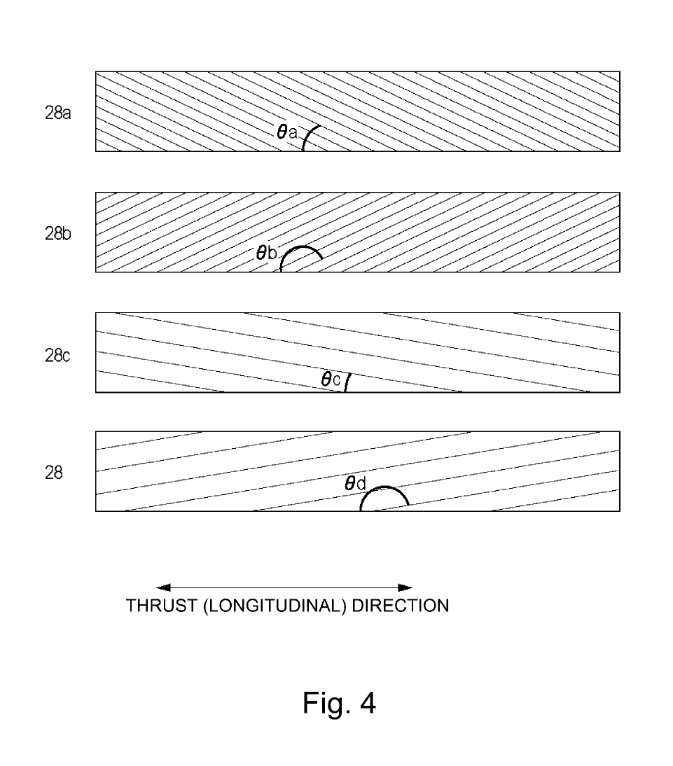

FIG. 4 is an enlarged view of the surface of the developing sleeve 28.

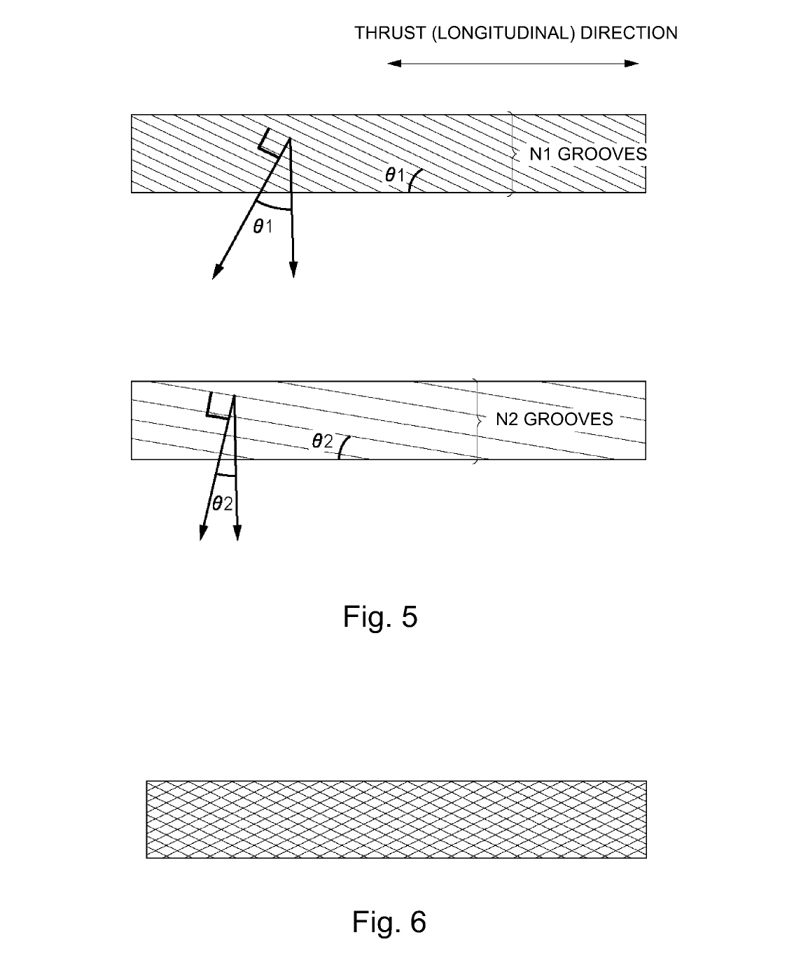

The surface of the developing sleeve 28 of this embodiment is provided with helical grooves which are linear with a inclination angle relative to the generating line, when the surface of the developing sleeve 28 is developed on a flat plane. The grooves are shown as simple inclined lines although they are actually helical, for easy understanding (The same applies to FIGS. 5 and 6, too). The helical grooves extend, when they are developed on a flat plane, with an inclination relative to the axial direction (generatrix line direction or thrust direction) of the developing sleeve. With the sleeve having the helical grooves, the stress imparted to the developer can be reduced when the developer passes under the regulating blade 29 for regulating the amount of the developer, and therefore, a developer lifetime can be extended. In addition, the material feeding grooves are inclined, and therefore, an impact caused when the developer passes under the regulating blade 29 can be eased, and the image defect attributable to the impact can be reduced.

In this embodiment, the depth of the grooves is approx. 50-200 μm. Using ordinary blasting methods, the depth is approx. 10 μm, but the depth of the grooves in the present invention is so large that the feeding power, for the developer, of the surface of the sleeve is very high as compared with those provided by the blasting methods. The deep of the grooves is preferably not less than a particle diameter of the carrier particles. The widths of the grooves are preferably 0.05-0.2 mm, and the intervals between the grooves are preferably approx. 0.5-1 mm. These values are selected for optimization of the used developing device.

As described above, the image forming apparatus of this embodiment is a full-color image formation system, and therefore, four developing devices 4 (4a, 4b, 4c, 4d) are used. In this embodiment, as shown in FIG. 4, the angles of the helical grooves of the developing sleeves 28 relative to the thrust direction (generatrix direction when developed on a flat plane) are different from one another. The angles θ of the grooves of the developing sleeves 28 (28a, 28b, 28c, 28d) are θa, θb, θc and θd, respectively. In an example of the angles of this embodiment, θa=approx. 35 degrees, θb=approx. 145 degrees, θc=approx. 15 degrees and θd=approx. 165 degrees.

A manufacturing method for the grooved sleeve of this embodiment will be described. The grooved sleeve is manufactured by machining Using a die having circular base provided with the number, corresponding to the number of the grooves, of cutting edges, the surface of the developing sleeve is machined. The angle of the groove is provided as follows. Opposite end portions of the rotation shaft of the developing roller is supported by a machining device, the developing sleeve is pushed in the longitudinal direction of the developing sleeve toward the die while rotating the developing sleeve, by which the grooves are cut given the predetermined angles. The different angles of the grooves can be provided by changing the rotational speed of the developing sleeve in this machining method.

By doing so, it can be avoided that the stressing, in the full-color image output, of the slight bandings of respective monochromatic images appearing in the angle direction of the grooved sleeves. In addition, the bandings in the different directions can be canceled one another, and therefore, the banding is reduced in the final output image.

The banding reduction effect can be provided when the respective color images are finally overlaid after the transfer step, irrespective of the combination of the grooved sleeves.

As an example, the angles of the grooves may correspond to the angles of the screen process used in the image processing. By 90 degree offset between thee groove angle relative to the thrust direction and the screen angle in the image processing, the banding can be less remarkable. Ordinarily, the screen angles of the different colors are made different for the purpose of reducing the moire, the groove angles can be made different by making them correspond to the screen angles, respectively. In addition, a pitch non-uniformity caused by the screen angles and the groove angles can be minimized, and therefore, the image quality can be further improved. In this embodiment, 0 degree of the screen angle is not used, since then the angle θ of the grooves is 90 degrees, which means small feeding force of the grooves of the sleeve.

In place of the helical grooves, crossing grooves as shown in FIG. 6 may be used with the similar effects. In such a case, the helical grooves inclined in one direction cross with the other grooves extending in the opposite direction. The angle of said one direction and the angel of the opposite direction is not inevitably the same.

In the foregoing, all of the grooves are inclined relative to the thrust direction of the developing sleeve, one or more grooves parallel with the thrust direction may be provided, if the parallel grooves for different colors are not in overlapping relationship. It is not inevitable that all of the developing sleeves have the grooves, and the present invention is applicable when at least two developing sleeves have the grooves. For example, a part of the developing devices may have a blast treated developing sleeve or blast treated sleeves.

In this manner, in this embodiment, the angles of the grooves are made different for respective developing devices. Therefore, the patterns of the grooves with respect to the rotational moving direction of the developing sleeve can be made different. Therefore, the overlapping of the grooves for the different colors can be suppressed. In addition, in this embodiment, the pitches, as measured in the circumferential direction, of the grooves of the developing devices are made different. Therefore, the overlapping of the grooves can be suppressed.

### Embodiment 2

In the image forming apparatus of Embodiment 1, the inclinations of the developing devices are different, and therefore, the developer feeding performances of the different developing devices are different.

The feeding force provided by the groove of the sleeve is applied in the perpendicular direction of the groove. FIG. 5 shows a plan view of the developing sleeves, in which the helical grooves are shown by simple inclined lines for simplicity. in the case of the inclined (helical) groove, as shown in FIG. 5, the feeding force is cos θ multiplied by the feeding force in the perpendicular direction to the groove, where θ is an angle between the groove and the thrust direction of the developing sleeve.

Therefore, if the inclination of the groove is different, the feeding force of the developing sleeve is different, and therefore, the developer amount in the layer of the developer formed on the developing sleeve is different.

If the developer amount on developing sleeve is different, the development property is different. Here, the development property is a movement distance of the toner when a predetermined electric field is applied between the developing sleeve and the photosensitive drum.

In this embodiment, the development property is made unchanged even if the angle of the groove is different in the system having a plurality of developing devices.

More particularly, the number of the grooves is changed depending on the angle of the groove. The feeding force of the developing sleeve is proportional to the number of the grooves, and on the other hand, the feeding force of the developing sleeve decreases with increase of the angle of the groove since the cos θ component decreased; in view of this, the number of the grooves is increased with increase of the angle of the groove. By doing so, the feeding force is made the same even if the angle of the groove is different. FIG. 5 shows a model of the number of the groove relative to the different angles of the groove.

The developer feeding force a in the rotational moving direction of the developing sleeve is α=A cos θ+B.

Here, A is the feeding force of the groove in the perpendicular direction determined by the depth of the groove. B is the feeding force provided by the coarseness of the surface of the sleeve.

The developer feeding force of the sleeve surface is large when the depth of the groove is large.

In this embodiment, the feeding force is converted to the developer feeding amount provided by the sleeve. The feeding force B is determined as the developer amount fed on the sleeve without the groove, and the feeding force A of the groove is determined as the developer amount fed on the sleeve when the groove is in parallel with the thrust minus the amount B.

In this embodiment, A=20 mg/cm̂2, B=10 mg/cm̂2.

The values A and B may be determined in another manner.

In this embodiment, the number of the grooves is changed in accordance with the angle θ of the groove so as to make the feeding force a of the sleeve is substantially constant. That is, when the θ1 is large, and therefore, cos θ1 is small, the number N1 of the grooves is made large (small pitch, as measured in the circumferential direction, of the grooves). On the other hand, when the θ2 is small, and therefore, cos θ2 is large, the number N2 of the grooves is made small (large pitch, as measured in the circumferential direction, of the grooves).

As a result, the banding can be reduced, and the tone gradation property is good (high image quality) in the image forming apparatus. In place of the number of the grooves, the depth of the groove may be made different to make the feeding forces substantially the same, or both methods may be used.

Similarly to the previous embodiment, the crossing helical grooves are usable in this embodiment.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 241442/2011 filed Nov. 2, 2011 which is hereby incorporated by reference.

What is claimed is:

1. An image forming apparatus comprising:
a plurality of developing devices each including a developer carrying member for carrying a developer to develop an electrostatic latent image; and
an image forming station capable of forming a toner image on a recording material by overlapping toner images formed by said developing devices,
wherein in at least two of said developing devices, said developer carrying member has a surface provided with grooves at predetermined intervals as measured in a circumferential direction of said developer carrying member, and wherein angles of the grooves relative to respective directions of generatrixes of said developer carrying members are different from each other.

2. An apparatus according to claim 1, wherein a groove formation condition is different in accordance with the angle of the groove.

3. An apparatus according to claim 1, wherein the intervals increase with decrease of the angle.

4. An apparatus according to claim 1, wherein a depth of the groove decreases with decrease of the angle.

5. An apparatus according to claim 1, wherein the groove is substantially perpendicular to a screen angle of the image to be developed.

6. An image forming apparatus comprising:
a plurality of developing devices each including a developer carrying member for carrying a developer to develop an electrostatic latent image; and
an image forming station capable of forming a toner image on a recording material by overlapping toner images formed by said developing devices,
wherein in at least two of said developing devices, said developer carrying member has a surface provided with grooves at predetermined intervals, and wherein patterns of the grooves of said developer carrying members are different from each other.

7. An image forming apparatus comprising:
a plurality of developing devices each including a developer carrying member for carrying a developer to develop an electrostatic latent image; and
an image forming station capable of forming a toner image on a recording material by overlapping toner images formed by said developing devices,
wherein in at least two of said developing devices, said developer carrying member has a surface provided with grooves at predetermined intervals as measured in a circumferential direction of said developer carrying member, and wherein intervals of the grooves of said developer carrying members are different from each other.
